(19) United States
(12) Patent Application Publication
(10) Pub. No.: US 2010/0250758 A1
(43) Pub. Date: Sep. 30, 2010

(54) COMMUNICATION SYSTEM, COMMUNICATION METHOD, AND SERVER MANAGEMENT APPARATUS

(75) Inventor: Yoshitaka Nakayama, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 12/743,140

(22) PCT Filed: Nov. 12, 2008
(86) PCT No.: PCT/JP2008/070576

§ 371 Date: May 14, 2010

(30) Foreign Application Priority Data
Nov. 22, 2007 (JP) 2007-302624

(51) Int. Cl. G06F 15/16; G06F 15/173

(52) U.S. Cl. 709/229; 709/230; 709/223

(57) ABSTRACT

A communication system which causes a terminal apparatus to access a server apparatus via a network includes a server management apparatus between the network and at least one server apparatus. The server management apparatus performs processing of establishing a session for a communication partner terminal via a control apparatus of the network using a predetermined signaling protocol to obtain a use permission of the network on behalf of the server apparatus.

### TECHNICAL FIELD

The present invention relates to a communication system which causes a terminal apparatus to access a server apparatus via a network.

### BACKGROUND ART

In a communication system which requires access control for use of a line of a carrier network to access a content server, it is necessary to use a predetermined signaling protocol to obtain a use permission of the carrier network, and establish a session with a communication partner terminal via the control apparatus of the carrier network. An example of the carrier network is an NGN (Next Generation Network) network. An example of the signaling protocol is SIP (Session Initiation Protocol).

FIG. 21 shows an example of the arrangement of a communication system of this type.

In the communication system shown in FIG. 21, a user network 100 including PC terminals 101 and 102 and a service provider network 200 including Web servers 201 and 202 are connected to each other via a carrier network 300. Web browsers 111 and 112, HTTP modules 113 and 114, and SIP-UAs (User Agents) 115 and 116 run on the PC terminals 101 and 102, respectively. Service provider applications 211 and 212, HTTP modules 213 and 214, and SIP-UAs 215 and 216 run on the Web servers 201 and 202, respectively.

The operation of the communication system in FIG. 21 will be described using an example in which a user refers to a content in one of the Web servers, for example, the Web server 201 using the Web browser in one of the PC terminals, for example, the Web browser 111 in the PC terminal 101.

When the user of the PC terminal 101 starts accessing the Web server 201 by operating the Web browser 111, the PC terminal 101 performs SIP session establishment processing for the Web server 201 via a SIP server 303 in the carrier network 300 using the SIP-UA 115. More specifically, the PC terminal 101 first transmits a SIP request (INVITE) to the Web server 201 via the SIP server 303. In response to it, the Web server 201 transmits a SIP response to the PC terminal 101 via the SIP server 303.

When relaying the SIP response to permit use, the SIP server 303 that relays the SIP message and SIP response sets routers 301 and 302 to enable use of a line of the carrier network 300 between the Web server 201 and the PC terminal 101. When a SIP session is thus established between the PC terminal 101 and the Web server 201, and setting is done to enable use of a line of the carrier network 300 between the Web server 201 and the PC terminal 101 via the routers 301 and 302, HTTP communication is performed between the PC terminal 101 and the Web server 201.

References that describe communication systems similar to that described with reference to FIG. 21 are Japanese Patent Laid-Open No. 2005-12655 (reference 1) and ““What's NGN? [Question 6] What is the mechanism of NGN of NTT?”, NIKKEI NETWORK ITpro PRO [searched on Nov. 8, 2008], Internet, <URL:http://itpro.nikkeibp.co.jp/article/COLUMN/20070125/259673/>” (reference 2).

### DISCLOSURE OF INVENTION

### Problems to be Solved by the Invention

In the communication system shown in FIG. 21, a PC terminal accesses a Web server via the carrier network which becomes usable upon obtaining a permission. For this access, the Web server itself needs to perform processing of obtaining the permission of making the carrier network intervene. For this reason, a Web server having no SIP-UA cannot provide a service such as content transmission to a PC terminal via the carrier network. Additionally, to enable to provide the service, all Web servers need to incorporate SIP-UAs.

It is an exemplary object of the invention to provide a communication system which allows even a Web server having no SIP-UA to provide a service such as content transmission to a PC terminal via a carrier network which becomes usable upon obtaining a permission.

### Means of Solution to the Problems

A communication system according to an exemplary aspect of the invention includes a server management apparatus including control means for performing processing of establishing a session for a communication partner terminal via a control apparatus of a network using a predetermined signaling protocol to obtain a use permission of the network on behalf of a server apparatus to which a terminal apparatus accesses via the network.

A communication method according to another exemplary aspect of the invention includes the first step of performing processing of establishing a session for a communication partner terminal via a control apparatus of a network using a predetermined signaling protocol to obtain a use permission of the network on behalf of a server apparatus to which a terminal apparatus accesses via the network.

A server management apparatus according to still another exemplary aspect of the invention includes control means for performing processing of establishing a session for a communication partner terminal via a control apparatus of a network using a predetermined signaling protocol to obtain a use permission of the network on behalf of at least one server apparatus that provides a service to a terminal apparatus via the network, the server management apparatus being provided between the server apparatus and the network.

A program according to still another exemplary aspect of the invention causes a computer constructing a server management apparatus provided between a network and at least one server apparatus that provides a service to a terminal apparatus via the network to function as control means for performing processing of establishing a session for a communication partner terminal via a control apparatus of the network using a predetermined signaling protocol to obtain a use permission of the network on behalf of the server apparatus.

### EFFECT OF THE INVENTION

According to the present invention, even a server apparatus having no predetermined signaling protocol such as SIP can provide a service such as content transmission to a terminal apparatus via a carrier network which becomes usable upon obtaining a permission.

### BRIEF DESCRIPTION OF DRAWINGS

FIG. 1 is a block diagram of a communication system according to the first exemplary embodiment of the present invention;

FIG. 2 is a block diagram showing an example of the arrangement of a communication session centralizing apparatus in the communication system according to the first exemplary embodiment of the present invention;

FIG. 3 is a block diagram showing an example of the arrangement of a Web server management apparatus in the communication system according to the first exemplary embodiment of the present invention;

FIG. 4A is a sequence chart showing an example of the operation of the communication system according to the first exemplary embodiment of the present invention;

FIG. 4B is a sequence chart showing an example of the operation of the communication system according to the first exemplary embodiment of the present invention;

FIG. 5 is a sequence chart of SIP session establishment processing to be performed by the communication session centralizing apparatus in the communication system according to the first exemplary embodiment of the present invention;

FIG. 6 is a sequence chart of SIP session establishment processing to be performed by the Web server management apparatus in the communication system according to the first exemplary embodiment of the present invention;

FIG. 7 is a sequence chart of SIP session disconnection processing to be performed by the Web server management apparatus in the communication system according to the first exemplary embodiment of the present invention;

FIG. 8 is a sequence chart of SIP session disconnection processing to be performed by the communication session centralizing apparatus in the communication system according to the first exemplary embodiment of the present invention;

FIG. 9 is a block diagram of a communication system according to the second exemplary embodiment of the present invention;

FIG. 10 is a block diagram showing an example of the arrangement of a PC terminal in the communication system according to the second exemplary embodiment of the present invention;

FIG. 11A is a sequence chart showing an example of the operation of the communication system according to the second exemplary embodiment of the present invention;

FIG. 11B is a sequence chart showing an example of the operation of the communication system according to the second exemplary embodiment of the present invention;

FIG. 12 is a sequence chart of SIP session establishment processing to be performed by the PC terminal in the communication system according to the second exemplary embodiment of the present invention;

FIG. 13 is a block diagram of a communication system according to the third exemplary embodiment of the present invention;

FIG. 14 is a block diagram showing an example of the arrangement of a Web server management apparatus in the communication system according to the third exemplary embodiment of the present invention;

FIG. 15A is a sequence chart showing an example of the operation of the communication system according to the third exemplary embodiment of the present invention;

FIG. 15B is a sequence chart showing an example of the operation of the communication system according to the third exemplary embodiment of the present invention;

FIG. 16 is a sequence chart of SIP session establishment processing to be performed by the Web server management apparatus in the communication system according to the third exemplary embodiment of the present invention;

FIG. 17 is a block diagram of a communication system according to the fourth exemplary embodiment of the present invention;

FIG. 18A is a sequence chart showing an example of the operation of the communication system according to the fourth exemplary embodiment of the present invention;

FIG. 18B is a sequence chart showing an example of the operation of the communication system according to the fourth exemplary embodiment of the present invention;

FIG. 19 is a block diagram showing the arrangement of a communication session centralizing apparatus according to the present invention;

FIG. 20 is a block diagram showing the arrangement of a communication system according to the present invention; and

FIG. 21 is a block diagram of a communication system related to the present invention.

### BEST MODE FOR CARRYING OUT THE INVENTION

The exemplary embodiments of the present invention will now be described in detail with reference to the accompanying drawings.

### First Exemplary Embodiment

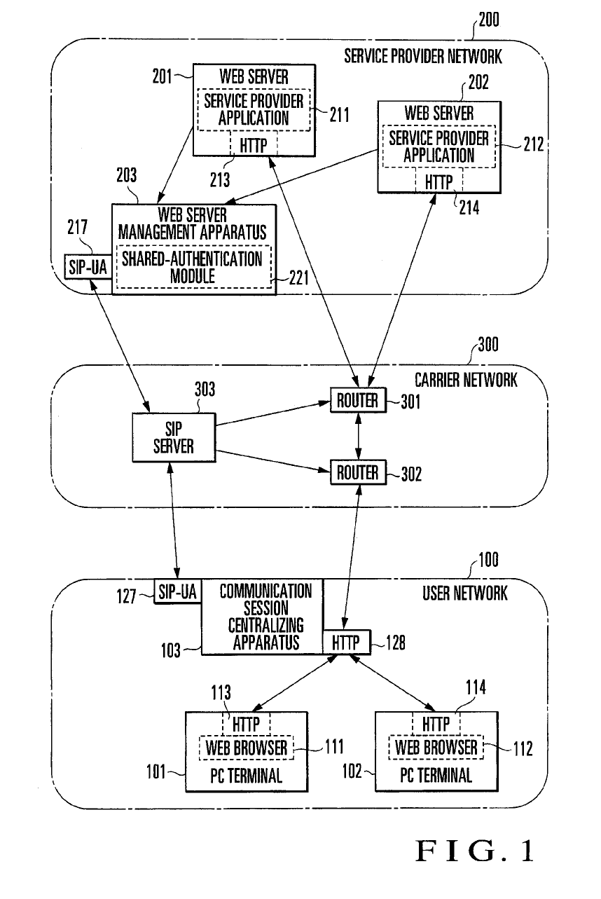

Referring to FIG. 1, a communication system according to the first exemplary embodiment of the present invention includes a user network 100, service provider network 200, and carrier network 300 which connects the two networks 100 and 200 to each other.

The user network 100 includes two PC (Personal Computer) terminals 101 and 102 and a communication session centralizing apparatus 103, which are connected to be communicable with each other. The PC terminals 101 and 102 and the communication session centralizing apparatus 103 may be connected directly physically via LAN (Local Area Network) cables or logically via a communication network. This network includes two PC terminals. However, the network need only include at least one PC terminal, and the number of PC terminals can be arbitrary.

Web browsers 111 and 112 to be used to refer to contents in Web servers run on the PC terminals 101 and 102, respectively. The PC terminals 101 and 102 also include HTTP modules 113 and 114, respectively, which perform HTTP (Hyper Text Transfer Protocol) communication with Web servers.

The communication session centralizing apparatus 103 has a SIP-UA function 127 of processing the SIP protocol on behalf of the PC terminal 101 or 102 that does not support the SIP protocol, and an HTTP communication proxy function 128.

The service provider network 200 includes two Web servers 201 and 202 and a Web server management apparatus 203, which are connected to be communicable with each other. The Web servers 201 and 202 and the Web server management apparatus 203 may be connected directly physically via LAN (Local Area Network) cables or logically via a communication network. This network includes two Web servers. However, the network need only include at least one Web server, and the number of Web servers can be arbitrary.

Service provider applications 211 and 212 which provide contents and the like run on the Web servers 201 and 202, respectively. The Web servers 201 and 202 also include HTTP modules 213 and 214, respectively, which perform HTTP communication with the PC terminals 101 and 102.

The Web server management apparatus 203 has a SIP-UA function 217 of processing the SIP protocol on behalf of the PC terminal 101 or 102 that does not support the SIP protocol. The Web server management apparatus also includes a shared-authentication module 221.

The shared-authentication module 221 controls permission/prohibition of SIP session establishment processing based on the presence/absence of an access authority of the users of the PC terminals 101 and 102 for the Web servers 201 and 202.

The carrier network 300 is an IP (Internet Protocol) network provided by a specific communication carrier. The carrier network 300 includes a plurality of routers 301 and 302 which are arranged on transmission lines to perform IP packet routing, and a SIP server 303 corresponding to the control apparatus of the carrier network 300, like, for example, an NGN (Next Generation Network) network.

Generally, the routers 301 and 302 are classified into routers called service edges which directly accommodate access lines and routers called relay nodes other than the service edges. The service edge has not only the routing function but also functions of, e.g., access control and band allocation. The relay node has a function of handling more traffics.

The SIP server 303 operates as a proxy when a SIP-UAC (User Agent Client) and a SIP-UAS (User Agent Server) establish a SIP session via the carrier network 300, and relays SIP messages between the SIP-UAC and the SIP-UAS. When the SIP session has been established between the SIP-UAC and the SIP-UAS, the SIP server 303 controls the routers 301 and 302 to give a permission of using a line of the carrier network 300 concerning the established SIP session. When the SIP session between the SIP-UAC and the SIP-UAS has been disconnected, the SIP server 303 controls the routers 301 and 302 to cancel the permission of using the line of the carrier network 300, which has been given concerning the SIP session.

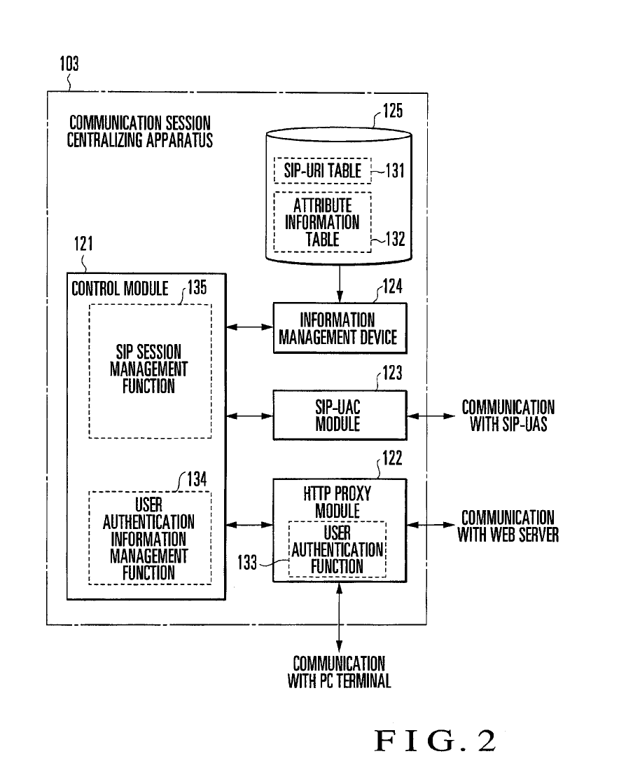

Referring to FIG. 2, the communication session centralizing apparatus 103 includes a control module 121, HTTP proxy module 122, SIP-UAC module 123, information management device 124, and storage device 125.

The storage device 125 is formed from a recording medium such as a magnetic disk, and stores a SIP-URI table 131 and an attribute information table 132 as information to be referred to when establishing a SIP session.

The SIP-URI table 131 holds the correspondence relationship between the domain names of the Web servers 201 and 202 and SIP-URIs in a one-to-one correspondence with the Web servers 201 and 202 managed by the Web server management apparatus 203, as shown in Table 1. The two SIP-URIs in a one-to-one correspondence with the Web servers 201 and 202 are the SIP-URIs of the Web server management apparatus 203. The two SIP-URIs are set in the single Web server management apparatus 203 to identify, by the SIP-URI, which one of the Web servers 201 and 202 is being accessed. Note that as another method of identifying, by the SIP-URI, which one of the Web servers 201 and 202 is being accessed, an isub line may be described next to a semicolon “;” at the end of the SIP-URI.

TABLE 1

| Domain name of | SIP-URI of Web server |
|---|---|
| Web server | management apparatus |
| www.abc.com | sip:abc@com |
| www.xyz.co.jp | sip:xyz@co.jp |

The attribute information table 132 holds the correspondence relationship between user ID that uniquely identify the users of the PC terminals 101 and 102, the SIP-URIs in a one-to-one correspondence with the Web servers 201 and 202 managed by the Web server management apparatus 203, and attribute information, as shown in Table 2. The attribute information represents, e.g., the quality of a communication channel to be used based on a permission obtained from the carrier network 300, such as a QoS value or best effort instruction. Note that in the examples of Tables 1 and 2, attribute information is held for each SIP-URI on the Web server side. Instead, the attribute information table 132 may hold the correspondence relationship between the user IDs and the attribute information without describing the SIP-URIs on the Web server side.

TABLE 2

| | SIP-URI of Web server | Attribute |
|---|---|---|
| User ID | management apparatus | information |
| taro | sip:abc@com | QoS = x |
| | sip:xyz@co.jp | QoS = y |
| hanako | sip:abc@com | QoS = z |
| | sip:xyz@co.jp | best effort |

The information management device 124 is responsible for processing of searching the SIP-URI table 131 and the attribute information table 132 in accordance with a request from the control module 121 and transferring information to be used to establish a SIP session to the control module 121. Note that the information management device 124 and the storage device 125 may be provided in a server outside the communication session centralizing apparatus 103 so as to transfer necessary information by communication between the communication session centralizing apparatus 103 and the external server.

The HTTP proxy module 122 intervenes between the PC terminals 101 and 102 and the Web servers 201 and 202 to relay HTTP messages. The HTTP proxy module 122 authenticates the user of the PC terminal 101 or 102 using a proxy user authentication function 133 when he/she is going to access the Web server 201 or 202.

The SIP-UAC module 123 communicates with the SIP-UAS to, e.g., establish or disconnect a SIP session. In this exemplary embodiment, the SIP-UAS is the Web server management apparatus 203.

The control module 121 performs main control of the communication session centralizing apparatus 103, and has a user authentication information management function 134 and a SIP session management function 135. The user authentication information management function 134 is a storage means for holding and managing the correspondence relationship between the information (e.g., user ID) of a user obtained when the user authentication function 133 has succeeded in user authentication and a SIP-URI assigned to the user. On the other hand, the SIP session management function 135 is a storage means for holding and managing the correspondence relationship between a SIP-URI assigned to a user, a SIP-URI assigned to a partner for which a SIP session has been established using the user's SIP-URI as a client SIP-URI, and a SIP session identifier that uniquely identifies the established SIP session. As the SIP session identifier, for example, a Call-ID is used.

Using the user authentication information management function 134 and the SIP session management function 135, the control module 121 controls establishment and disconnection of a SIP session for each user whose authentication by the user authentication function 133 has succeeded.

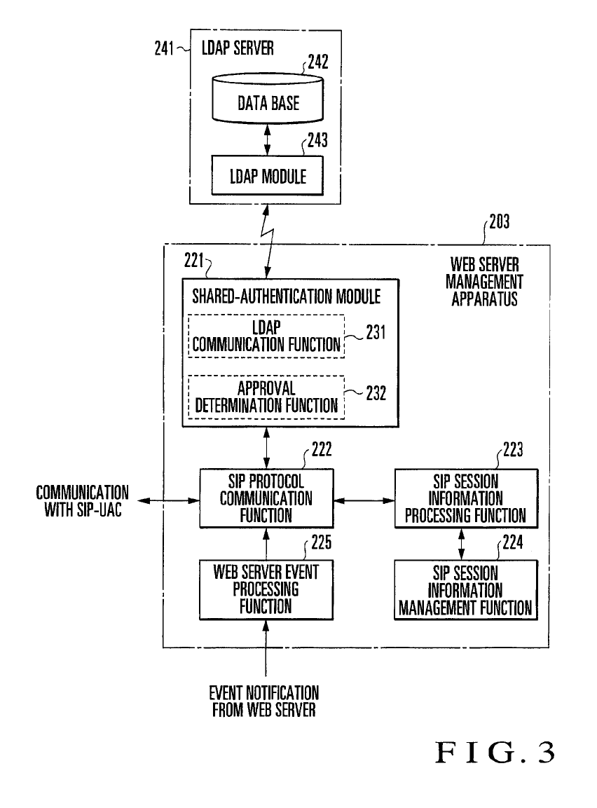

Referring to FIG. 3, the Web server management apparatus 203 includes a shared-authentication module 221, SIP protocol communication function 222 (control means), SIP session information processing function 223, SIP session information management function 224, and Web server event processing function 225.

The SIP protocol communication function 222 is a module which communicates with the SIP-UAC on behalf of the Web server 201 or 202 to establish and disconnect a SIP session. In this exemplary embodiment, the SIP-UAC is the communication session centralizing apparatus 103. Upon receiving a SIP message (INVITE) that requests SIP session establishment from the SIP-UAC, the SIP protocol communication function 222 causes the shared-authentication module 221 to determine whether a client specified by a client-side SIP-URI contained in the SIP message has an authority to access a Web server specified by a server-side SIP-URI contained in the SIP message. If the client has an access authority, the SIP protocol communication function 222 returns a permission response in response to the SIP message (INVITE). If the client has no access authority, the SIP protocol communication function 222 returns a prohibition response. The SIP protocol communication function 222 also has a function of including, in a SIP message, the IP address of the Web server specified by the server-side SIP-URI and sending it when a SIP session has been established.

The SIP session information management function 224 includes a recording medium such as magnetic disk, and holds SIP session status information between SIP-URIs in a one-to-one correspondence with the Web servers 201 and 202 managed by the Web server management apparatus 203 and the SIP-URIs of clients which are accessing the Web servers. More specifically, the SIP session information management function 224 holds, as SIP session status information, information including a pair of a SIP-URI on the side of a server with an established SIP session and a SIP-URI on the side of a client which is accessing the Web server, and a SIP session identifier.

The SIP session information processing function 223 receives a notification of SIP session establishment or disconnection from the SIP protocol communication function 222, and adds/deletes SIP session status information to/from the SIP session information management function 224. Upon receiving a query with a designated SIP session identifier from the SIP protocol communication function 222, the SIP session information processing function 223 searches the SIP session information management function 224 for a Web-server-side SIP-URI and client-side SIP-URI, and returns the response.

The shared-authentication module 221 has a function of receiving, from the SIP protocol communication function 222, a client-side SIP-URI and Web-server-side SIP-URI contained in a SIP message (INVITE) received from the SIP-UAC, and determining whether the client specified by the client-side SIP-URI has an authority to access the Web server specified by the server-side SIP-URI. To implement this function, the shared-authentication module 221 has an LDAP (Lightweight Directory Access Protocol) communication function 231 of communicating with an LDAP server 241 provided outside, and an approval determination function 232.

A database 242 of the LDAP server 241 holds a list of sets of server-side SIP-URIs and their attributes (permission/prohibition) for each client-side SIP-URI. Upon receiving a list query with a designated client-side SIP-URI from the shared-authentication module 221, an LDAP module 243 searches the database 242 based on the client-side SIP-URI, acquires the list of sets of server-side SIP-URIs and their attributes corresponding to the client-side SIP-URI, and returns it to the shared-authentication module 221.

The LDAP communication function 231 of the shared-authentication module 221 sends a list query to the LDAP server 241 while designating the client-side SIP-URI received from the SIP protocol communication function 222, and acquires the list of sets of server-side SIP-URIs and their attributes (permission/prohibition) corresponding to the client-side SIP-URI. If the server-side SIP-URI received from the SIP protocol communication function 222 exists in the acquired list, and its attribute is “permission”, the approval determination function 232 determines that the client specified by the client-side SIP-URI has an authority to access the Web server specified by the server-side SIP-URI. Otherwise, the approval determination function 232 determines that the client has no access authority. The approval determination function 232 sends the determination result to the SIP protocol communication function 222.

Note that in this exemplary embodiment, the LDAP server 241 is used. However, the means for holding the list of sets of server-side SIP-URIs and their attributes (permission/prohibition) for each client-side SIP-URI is not limited to the LDAP server. The list may be held in an arbitrary protocol server or a local file on the side of the shared-authentication module 221. Instead of holding attributes, a list of permitted server-side SIP-URIs, or conversely, a list of access-prohibited server-side SIP-URIs may be held.

The Web server event processing function 225 receives an event notification from the Web server 201 or 202, and requests the SIP protocol communication function 222 to perform processing corresponding to the contents of the received event notification. More specifically, upon receiving a logout event notification containing a SIP session identifier or an event notification containing a SIP session identifier and representing a login process failure from the Web server 201 or 202, the Web server event processing function 225 sends a SIP session disconnection request to the SIP protocol communication function 222 together with the SIP session identifier.

A detailed operation of the communication system according to the exemplary embodiment will be described next using an example in which the user of the PC terminal 101 refers to a content in the Web server 201 using the Web browser 111.

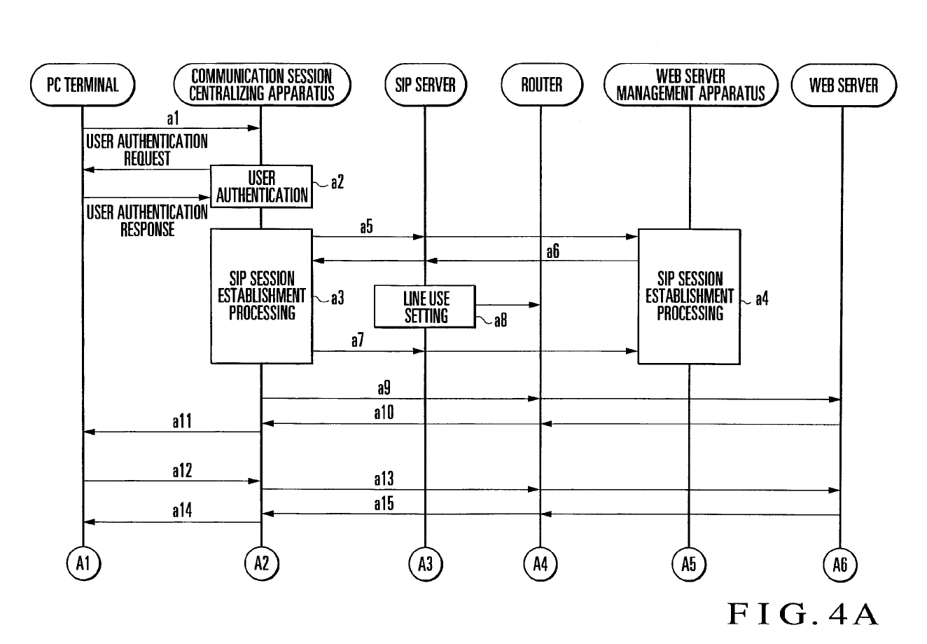

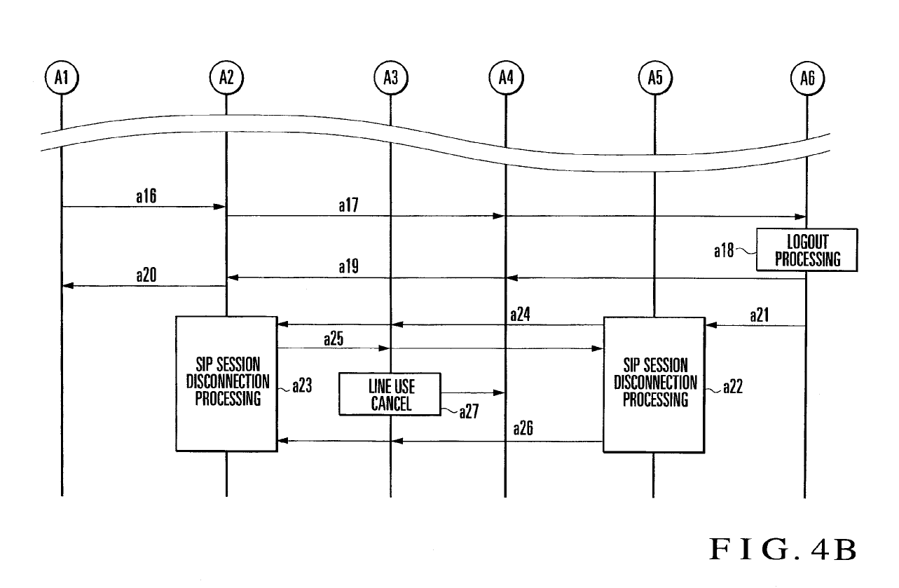

Referring to FIG. 4A, first, to start accessing, for example, a Web server, the Web browser 111 of the PC terminal 101 outputs an HTTP request to the Web server 201 (a1). The HTTP proxy module 122 of the communication session centralizing apparatus 103 to which the PC terminal 101 is connected acquires (handles) the HTTP request output from the PC terminal 101.

Next, the HTTP proxy module 122 performs user authentication for the PC terminal 101 using the user authentication function 133 (a2). For example, the HTTP proxy module 122 requests the PC terminal 101 to input authentication information such as a user ID and password, and collates the authentication information input from the PC terminal 101 in accordance with the request with preset authentication information, thereby performing user authentication. The user authentication a2 is executed only once when the user of the PC terminal 101 accesses the communication session centralizing apparatus 103 for the first time.

When the user authentication has succeeded, the communication session centralizing apparatus 103 establishes, via the SIP server 303 of the carrier network 300, a SIP session between the PC terminal 101 and the Web server management apparatus 203 which manages the Web server 201 of the HTTP request destination (a3 and a4). The SIP session establishment processing is generally performed in the following way, and a more detailed description thereof will be made later.

First, the communication session centralizing apparatus 103 transmits a SIP request (INVITE) to the Web server management apparatus 203 via the SIP server 303 (a5). The SIP request includes a client-side SIP-URI the communication session centralizing apparatus 103 has assigned to the user of the PC terminal 101 who has undergone the authentication information this time, a Web-server-side SIP-URI that is a SIP-URI in a one-to-one correspondence with the Web server 201 of the HTTP request destination, and an attribute such as QoS when using the carrier network 300. The Web server management apparatus 203 analyzes the received SIP request, and confirms whether the user specified by the client-side SIP-URI has an authority to use the Web server 201 specified by the Web-server-side SIP-URI. Upon confirming that the user can use the Web server, the Web server management apparatus 203 transmits a SIP response representing a permission to the communication session centralizing apparatus 103 via the SIP server 303. On the other hand, if the user cannot use the Web server, the Web server management apparatus 203 transmits a SIP response representing a prohibition to the communication session centralizing apparatus 103 via the SIP server 303 (a6). The SIP response includes the IP address of the Web server 201. Upon receiving the SIP response, the communication session centralizing apparatus 103 transmits ACK for the SIP response to the Web server management apparatus 203 via the SIP server 303 (a7).

When receiving the SIP response representing a permission from the Web server management apparatus 203 and transferring it to the communication session centralizing apparatus 103, the SIP server 303 that relays the SIP response sets the routers 301 and 302 such that a line of the carrier network 300 can be used between the Web server 201 specified by the server-side SIP-URI contained in the SIP response (or SIP request) and the communication session centralizing apparatus 103 specified by the client-side SIP-URI (a8). At this time, if attribute information about communication quality such as QoS is designated, band allocation is done to satisfy the designated quality. The routers 301 and 302 may be set not when transferring the SIP response but when receiving ACK for the SIP response from the communication session centralizing apparatus 103 and transferring it to the Web server management apparatus 203. The SIP server 303 which has done the use setting stores information to be used to cancel the current use setting in correspondence with the identifier of the currently established SIP session so as to prepare for later cancel of the use setting. What kind of information should be stored depends on the carrier network 300.

In the above-described way, the SIP session is established between the communication session centralizing apparatus 103 and the Web server management apparatus 203, and setting is done to allow the Web server 201 and the communication session centralizing apparatus 103 to use a line of the carrier network 300 via the routers 301 and 302. Then, the HTTP proxy module 122 of the communication session centralizing apparatus 103 transmits the HTTP request received from the PC terminal 101 to the router 302 of the carrier network 300 (a9). The HTTP request transmitted to the router 302 propagates through the carrier network 300 and is sent to the Web server 201 via the router 301. The Web server 201 executes processing corresponding to the received HTTP request, and transmits an HTTP response to the router 301 of the carrier network 300 (a10).

The HTTP response transmitted to the router 301 propagates through the carrier network 300 and is sent to the communication session centralizing apparatus 103 via the router 302. The HTTP proxy module 122 of the communication session centralizing apparatus 103 transmits the received HTTP response to the PC terminal 101 (a11). The HTTP response is a response to the HTTP request a1 transmitted from the PC terminal 101. By the transmission/reception of the HTTP request a1 and the HTTP response a11, an HTTP session is established between the communication session centralizing apparatus 103 and the Web server 201.

When the SIP session has been established, the HTTP proxy module 122 stores the correspondence between the Web-server-side IP address obtained from the SIP response and the SIP session identifier to be used to uniquely identify the established SIP session. When performing HTTP communication with the Web server 201, the HTTP proxy module 122 stores the SIP session identifier in the extension header.

From then on, normal HTTP communication is performed between the PC terminal 101 and the Web server 201 via the HTTP proxy module 122 of the communication session centralizing apparatus 103 (a12 to a15). When the service provider application 211 of the Web server 201 manages user's login and logout states, a login operation is performed between the PC terminal 101 and the Web server 201 via the normal HTTP communication.

An operation to be performed when the user of the PC terminal 101 logs out from the Web server 201 will be described next.

As shown in FIG. 4B, when the user of the PC terminal 101 logs out from the Web server 201, the PC terminal 101 transmits an HTTP request representing it to the HTTP proxy module 122 of the communication session centralizing apparatus 103 (a16). The HTTP proxy module 122 transmits the received HTTP request to the Web server 201 via the routers 302 and 301 (a17). The Web server 201 analyzes the received HTTP request, and performs logout processing (a18). The Web server 201 then transmits an HTTP response to the communication session centralizing apparatus 103 via the carrier network 300 (a19). The HTTP proxy module 122 of the communication session centralizing apparatus 103 transmits the received HTTP response to the PC terminal 101 (a20). The HTTP session between the PC terminal 101 and the Web server 201 is thus disconnected.

On the other hand, the Web server 201 which has performed the logout processing a18 sends a logout event notification to the Web server management apparatus 203 (a21). The SIP session identifier stored in the extension header of the HTTP request received from the PC terminal 101 is added to the logout event. In accordance with the logout event from the Web server 201, the Web server management apparatus 203 performs SIP session disconnection processing between the Web server and the communication session centralizing apparatus 103 via the SIP server 303 of the carrier network 300 (a22 and a23). The SIP session disconnection processing is generally performed in the following way, and a more detailed description thereof will be made later.

First, the Web server management apparatus 203 transmits a SIP request (BYE) to the communication session centralizing apparatus 103 via the SIP server 303 (a24). The SIP request includes the SIP session identifier of the SIP session to be disconnected, the client-side SIP-URI, and the Web-server-side SIP-URI. The communication session centralizing apparatus 103 analyzes the received SIP request, disconnects the SIP session specified by the SIP session identifier, and transmits a SIP response to the Web server management apparatus 203 via the SIP server 303 (a25). Upon receiving the SIP response, the Web server management apparatus 203 transmits ACK for the SIP response to the communication session centralizing apparatus 103 via the SIP server 303 (a26).

When receiving the SIP response representing SIP session disconnection from the communication session centralizing apparatus 103 and transferring it to the Web server management apparatus 203, the SIP server 303 that relays the SIP response controls the routers 301 and 302 to cancel the use setting of the carrier network 300 between the Web server 201 and the communication session centralizing apparatus 103 by referring to the information stored in correspondence with the SIP session identifier contained in the SIP response (a27).

Setting of the routers 301 and 302 may be canceled not when transferring the SIP response but when receiving ACK for the SIP response from the Web server management apparatus 203 and transferring it to the communication session centralizing apparatus 103.

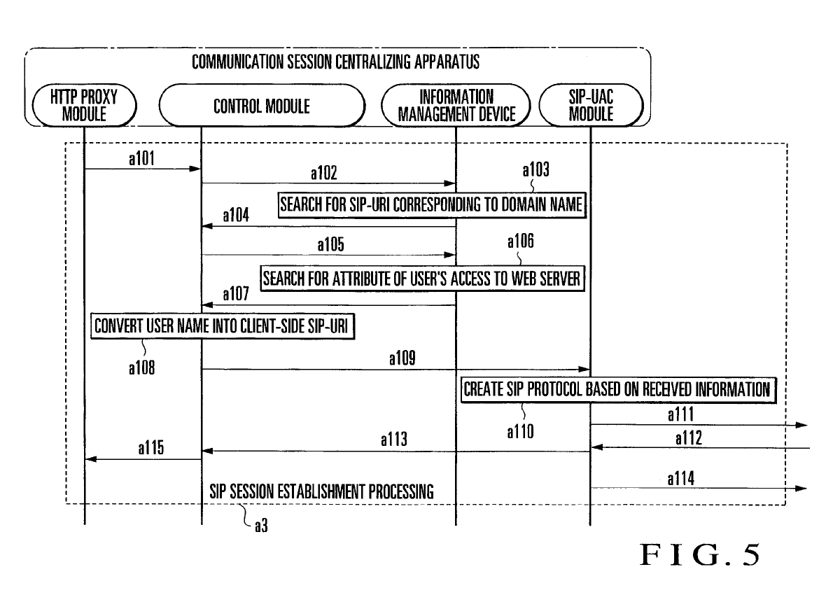

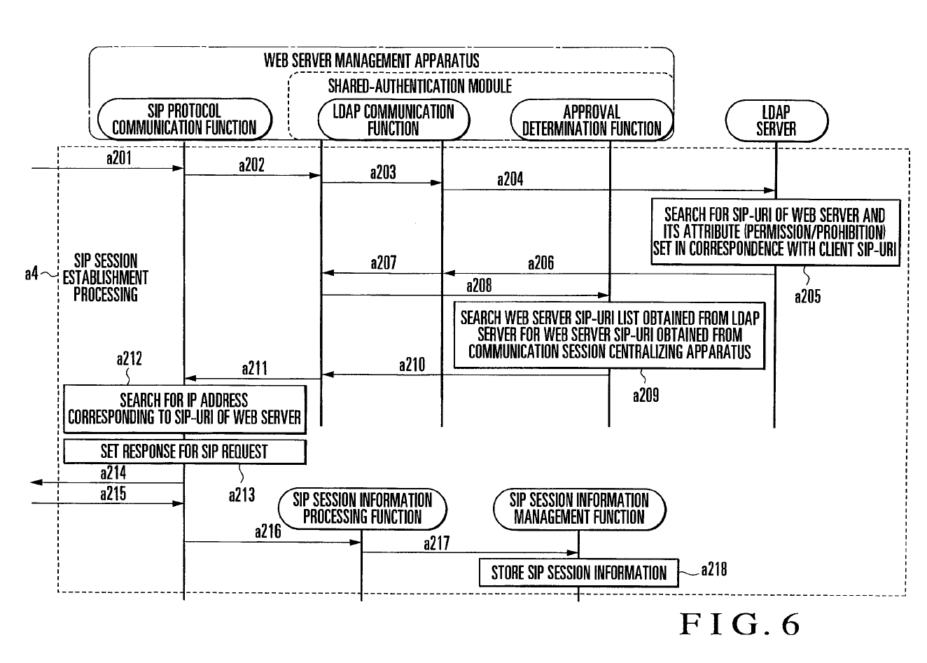

The SIP session establishment processes a3 and a4 in FIG. 4A will be described next in detail with reference to FIGS. 5 and 6.

Referring to FIG. 5, the HTTP proxy module 122 of the communication session centralizing apparatus 103 notifies the control module 121 of the domain name of the URL of the Web server 201 contained in the HTTP request received from the PC terminal 101 and the user name recognized by user authentication (a101).

The control module 121 sends the domain name of the URL of the Web server 201 to the information management device 124, and requests it to acquire the Web-server-side SIP-URI corresponding to the domain name (a102). The information management device 124 searches the SIP-URI table 131 for the Web-server-side SIP-URI corresponding to the received domain name (a103). The information management device 124 sends the found Web-server-side SIP-URI to the control module 121 (a104). For example, if the domain name of the URL of the Web server 201 is www.abc.com, sip:abc@com is searched for in the examples of Tables 1 and 2.

Next, the control module 121 sends the user name and the Web-server-side SIP-URI to the information management device 124, and requests it to acquire attribute information (a105). The information management device 124 searches the attribute information table 132 for attribute information (attribute of user's access to a Web server) corresponding to the combination of the received user name and Web-server-side SIP-URI (a106). The information management device 124 sends the found attribute information to the control module 121 (a107). For example, if the user name is taro, and the Web-server-side SIP-URI is sip:abc@com, QoS=x is searched for in the examples of Tables 1 and 2.

The control module 121 converts the user name into a client-side SIP-URI (a108), sends the client-side SIP-URI, Web-server-side SIP-URI, and attribute information to the SIP-UAC module 123, and requests it to start a SIP session (a109). The user name is converted into a client-side SIP-URI by, for example, selecting a SIP-URI currently not in use from one or more SIP-URIs delivered from the carrier network 300 to the communication session centralizing apparatus 103. The correspondence relationship between the user name and the SIP-URI assigned to it is held by the user authentication information management function 134.

In accordance with the request from the control module 121, the SIP-UAC module 123 creates a SIP request (INVITE: SIP protocol) based on the received information (a110). The SIP-UAC module 123 transmits the created SIP request (INVITE) to the SIP server 303 of the carrier network 300 (a111). The Web-server-side SIP-URI is set in the Request-URI and To header of the SIP request. The client-side SIP-URI is set in the From header. The attribute information is described in the SDP (Session Description Protocol) field.

As described with reference to FIG. 4A, the SIP server 303 transmits the received SIP request to the Web server management apparatus 203 specified by the server-side SIP-URI described in the To header (a5).

Referring to FIG. 6, the SIP protocol communication function 222 of the Web server management apparatus 203 receives the SIP request from the communication session centralizing apparatus 103 via the SIP server 303 of the carrier network 300 (a201), and sends the client-side SIP-URI and the Web-server-side SIP-URI contained in the received SIP request to the shared-authentication module 221 (a202).

The shared-authentication module 221 sends the received client-side SIP-URI to the LDAP communication function 231 (a203). The LDAP communication function 231 sends the client-side SIP-URI to the LDAP server 241 (a204). The LDAP module 243 of the LDAP server 241 searches the database 242 using the client-side SIP-URI as a key (a205). By this search, the LDAP module 243 acquires a list of sets of Web-server-side SIP-URIs and their attributes (permission/prohibition) set for the client-side SIP-URI. Next, the LDAP module 243 transmits the acquired list of sets of Web-server-side SIP-URIs and their attributes to the LDAP communication function 231 (a206). The LDAP communication function 231 sends the received information to the shared-authentication module 221 (a207).

The shared-authentication module 221 adds the list of sets of Web-server-side SIP-URIs and their attributes received from the LDAP server 241 via the LDAP communication function 231 to the Web-server-side SIP-URI received from the SIP protocol communication function 222, and sends it to the approval determination function 232 as a determination target server-side SIP-URI (a208). The approval determination function 232 checks whether the determination target server-side SIP-URI (the server-side SIP-URI received from the communication session centralizing apparatus) exists in the list (the server-side SIP-URI list obtained from the LDAP server) of sets of Web-server-side SIP-URIs and their attributes. Only when the server-side SIP-URI exists in the list, and its attribute is “permission”, the approval determination function 232 determines to permit. Otherwise, the approval determination function 232 determines to prohibit (a209). The approval determination function 232 sends the determined approval result to the shared-authentication module 221 (a210). If the SIP-URI obtained from the communication session centralizing apparatus exists in the SIP-URI list obtained from the LDAP server, the approval determination function 232 notifies the shared-authentication module 221 of a permission/prohibition based on the attribute. If the SIP-URI does not exist in the list, the approval determination function 232 notifies the shared-authentication module 221 of it. The shared-authentication module 221 sends the determination result from the approval determination function 232 to the SIP protocol communication function 222 (a211).

Upon receiving the approval result notification, the SIP protocol communication function 222 first searches for an IP address corresponding to the Web-server-side SIP-URI (a212). This search is done by, for example, storing, in the Web server management apparatus 203, a correspondence list of the IP addresses of the Web servers 201 and 202 managed by the apparatus and server-side SIP-URIs set in the apparatus 203 in a one-to-one correspondence with the Web servers 201 and 202, and searching for the correspondence list based on the Web-server-side SIP-URI.

The SIP protocol communication function 222 next creates a response for the SIP request (a213), and transmits the created SIP response to the SIP server 303 of the carrier network 300 (a214). More specifically, upon receiving a permission result from the shared-authentication module 221, the SIP protocol communication function 222 creates “200 OK” as a SIP response and transmits it. Otherwise, the SIP protocol communication function 222 creates a SIP response representing an error such as “403 Forbidden” and transmits it. The SIP protocol communication function 222 stores the IP address of the Web server 201 in the SIP response. The IP address can be stored at an arbitrary location. For example, the IP address is stored in connection information represented by “c=” in the SDP field of the SIP response. For example, if the IP address of the Web server when communicating by the IPv4 protocol is 129.60.152.9, the connection information is described as c=IN IP4 129.60.152.9.

As described with reference to FIG. 4B, the SIP server 303 relays the received SIP response to the communication session centralizing apparatus 103. At this time, if the SIP response is “200 OK”, the SIP server 303 sets the routers 301 and 302 so as to allow the Web server 201 and the communication session centralizing apparatus 103 to use a line of the carrier network 300.

Referring to FIG. 5, upon receiving the SIP response (the SIP protocol of the SIP response stores the IP address of the Web server) from the SIP server 303 of the carrier network 300 (a112), the SIP-UAC module 123 of the communication session centralizing apparatus 103 notifies the control module 121 of the permission/prohibition of SIP session establishment that can be known from the SIP response (a113). The SIP-UAC module 123 also transmits ACK for the SIP response to the SIP protocol communication function 222 of the Web server management apparatus 203 via the SIP server 303 (a114). The control module 121 sends the SIP response received from the SIP-UAC module 123 to the HTTP proxy module 122 (a115). The control module 121 also registers the set of the client-side SIP-URI, server-side SIP-URI, and SIP session identifier in the SIP session management function 135 as information about the established SIP session.

The HTTP proxy module 122 acquires and holds the IP address of the Web server 201 contained in the received SIP response and the SIP session identifier of the established SIP session. When relaying HTTP communication between the PC terminal 101 and the Web server 201 specified by the IP address, the HTTP proxy module 122 stores the SIP session identifier in the extension header of an HTTP message.

Referring to FIG. 6, upon receiving ACK for the SIP response from the communication session centralizing apparatus 103 (a215), the SIP protocol communication function 222 of the Web server management apparatus 203 requests the SIP session information processing function 223 to set the status information of the established SIP session (a216). Upon receiving the request, the SIP session information processing function 223 stores the status information of the established SIP session in the SIP session information management function 224 (a217 and a218).

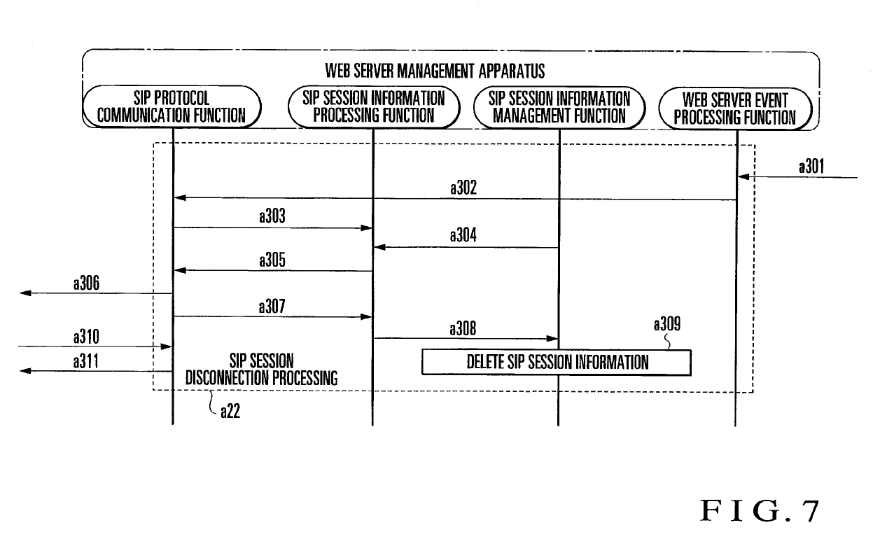

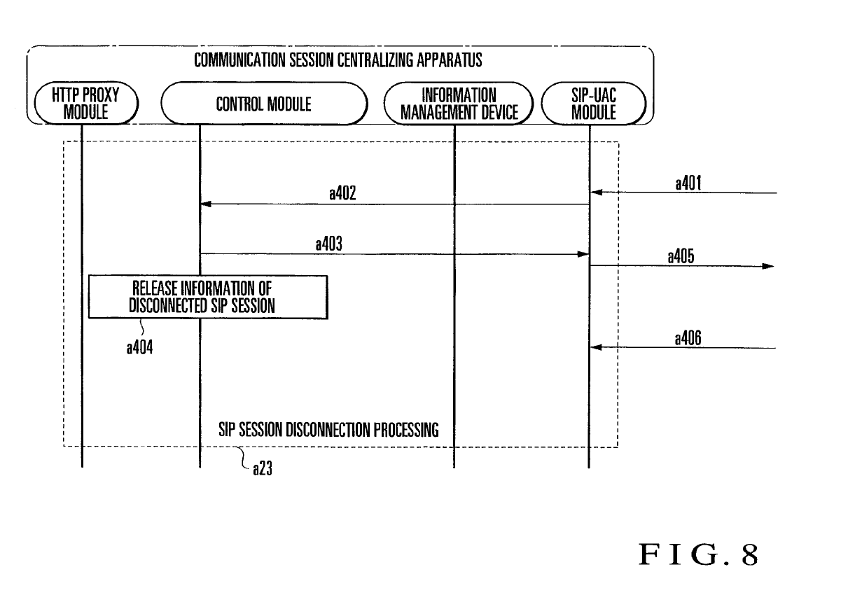

The SIP session disconnection processing in FIG. 4B will be described next in detail with reference to FIGS. 7 and 8.

Referring to FIG. 7, the Web server event processing function 225 of the Web server management apparatus 203 receives a logout event notification from the Web server 201 (a301), and requests the SIP protocol communication function 222 to disconnect the SIP session (a302). The SIP session identifier added to the logout event is added to the disconnection request.

Upon receiving the request, the SIP protocol communication function 222 sends a SIP session status information acquisition request to the SIP session information processing function 223 together with the received SIP session identifier (a303). The SIP session information processing function 223 acquires status information corresponding to the received SIP session identifier from the SIP session information management function 224 (a304), and sends it to the SIP protocol communication function 222 (a305).

Using the server-side SIP-URI, client-side SIP-URI, and SIP session identifier included in the received status information, the SIP protocol communication function 222 generates a SIP request (BYE) to disconnect the SIP session, and transmits it to the communication session centralizing apparatus 103 via the SIP server 303 (a306). Simultaneously, the SIP protocol communication function 222 sends a SIP session information release request to the SIP session information processing function 223 together with the SIP session identifier (a307). In response to the request, the SIP session information processing function 223 deletes SIP session status information containing the SIP session identifier from the SIP session information management function 224 (a308 and a309). After that, the SIP protocol communication function 222 receives a SIP response for the SIP request (BYE) (a310), and transmits ACK for the SIP response (a311).

Referring to FIG. 8, upon receiving the SIP request (BYE) from the SIP protocol communication function 222 of the Web server management apparatus 203 via the SIP server 303 (a401), the SIP-UAC module 123 of the communication session centralizing apparatus 103 sends a SIP session disconnection notification to the control module 121 (a402). The control module 121 returns a SIP session disconnection response to the SIP-UAC module 123 in response to the notification (a403). The control module 121 also deletes (releases) information about the disconnected SIP session from the SIP session management function 135 (a404). Only the session of the designated user is disconnected, and those of other users are maintained. Upon receiving the SIP session disconnection response from the control module 121, the SIP-UAC module 123 transmits a SIP response for the SIP request (BYE) to the Web server management apparatus 203 via the SIP server 303 (a405). After that, the SIP-UAC module 123 receives ACK for the SIP response (a406).

The effects of this exemplary embodiment will be explained next.

(1) It is unnecessary to implement the SIP protocol in the PC terminals 101 and 102. This is because the communication session centralizing apparatus 103 processes the SIP protocol on behalf of the PC terminals 101 and 102.

(2) The PC terminals 101 and 102 can receive a service from a Web server via the carrier network 300 in accordance with a simple procedure. The reason is as follows. The communication session centralizing apparatus 103 acquires an HTTP request from a PC terminal to a Web server, and SIP session establishment processing of obtaining a use permission of the carrier network 300 is automatically performed. The communication session centralizing apparatus 103 serves as an HTTP proxy, and the carrier network 300 relays HTTP messages between the PC terminal 101 or 102 and the Web server.

(3) When the Web browser 111 of the PC terminal 101 and the Web browser 112 of the PC terminal 102, which are managed by the single communication session centralizing apparatus 103, access the same Web server 201, or a plurality of Web browsers 111 in the single PC terminal 101 access the same Web server 201, i.e., when a plurality of clients access the same Web server, each client can access the Web server without being influenced by other clients. More specifically, each client can maintain the login state independently of logout of other clients from the Web server, use a communication band of the carrier network 300 independently of the communication bands used by other clients, and do use setting of the carrier network 300 based on the attribute of its own independently of the attributes (e.g., QoS) of other clients. This is because the communication session centralizing apparatus 103 establishes a SIP session to obtain the use permission of the carrier network 300 or disconnects the SIP session for each client. This effect is unavailable in a method of making a plurality of clients share a single SIP session.

(4) It is unnecessary to implement the SIP protocol in the Web servers 201 and 202. This is because the Web server management apparatus 203 processes the SIP protocol on behalf of the Web servers 201 and 202. Generally, the SIP protocol processing requires a high implementation cost including SIP session management. It is therefore possible to largely reduce the cost of creating an application program of the Web server.

(5) It is possible to prevent wasteful use setting of the carrier network 300 and effectively use the carrier network 300. Using the shared-authentication module enables to automatically perform access control to a limitedly accessible Web server without modifying the Web server. The reason is as follows. SIP session establishment processing of obtaining a use permission of the carrier network 300 to access the Web server and authentication processing of determining whether the client has an authority to use the Web server are shared. If the client has no authority to use the Web server, the SIP session itself is not established, and use setting of the carrier network 300 is not done. On the other hand, assume that a SIP session is established, and the use right of the carrier network 300 is given without checking the presence/absence of the access right to the Web server. In this case, if the client has no authority to use the Web server, the processing ends almost without using the line of the carrier network 300 obtained upon use setting.

(6) It is possible to prevent wastefully allocate a communication band of the carrier network 300. This is because in case of user's logout from a Web server or a login failure, the SIP session is quickly disconnected accordingly, and the network use permission is canceled. This saves the user of the PC terminal from instructing SIP session disconnection, and also enables quick disconnection as compared to SIP session disconnection performed in case of the absence of communication for a predetermined time.

### Second Exemplary Embodiment

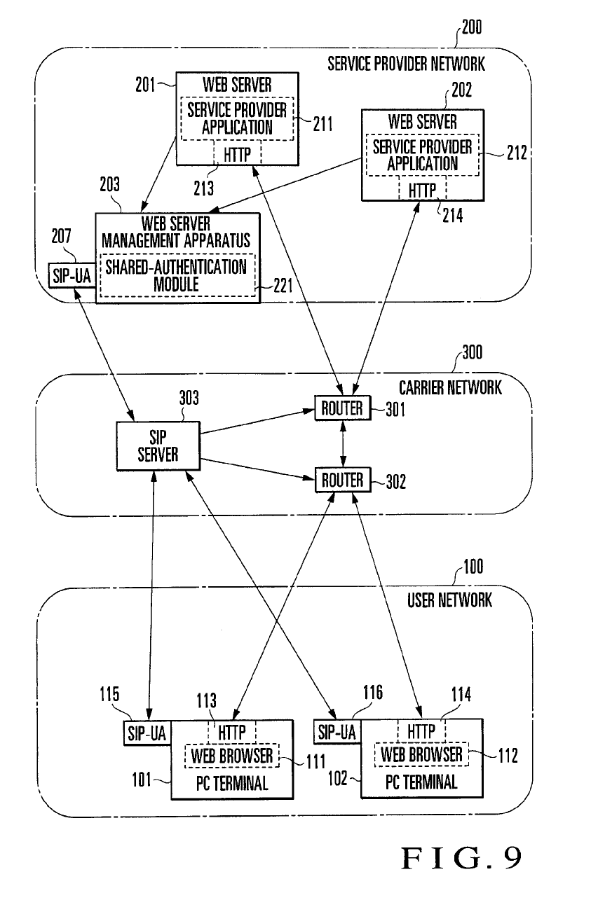

Referring to FIG. 9, a communication system according to the second exemplary embodiment of the present invention is different from the communication system shown in FIG. 1 in that PC terminals 101 and 102 themselves have SIP-UA functions 115 and 116, respectively. For this reason, a user network 100 does not include the communication session centralizing apparatus 103 shown in FIG. 1. The arrangement of this exemplary embodiment will be described below mainly concerning the points different from FIG. 1.

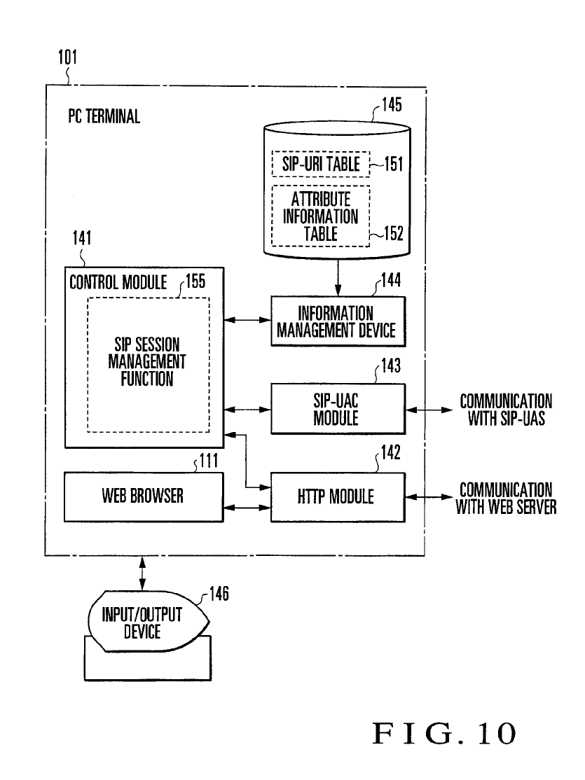

Referring to FIG. 10, the PC terminal 101 includes a control module 141, HTTP module 142, SIP-UAC (User Agent Client) module 143, information management device 144, storage device 145, and Web browser 111. An input/output device 146 formed from a keyboard and display is connected to the PC terminal 101.

The storage device 145 includes a storage medium such as a magnetic disk, and stores a SIP-URI table 151 and an attribute information table 152 as information to be referred when establishing a SIP session. The SIP-URI table 151 holds the contents shown in Table 1, like the SIP-URI table 131 of the exemplary embodiment shown in FIG. 1. The attribute information table 152 holds the contents shown in Table 2, like the attribute information table 132 of the exemplary embodiment shown in FIG. 1. However, if only one fixed user uses the PC terminal 101, the user ID can be omitted.

The information management device 144 is responsible for processing of searching the SIP-URI table 151 and the attribute information table 152 in accordance with a request from the control module 141 and transferring information to be used to establish a SIP session to the control module 141.

The HTTP module 142 transmits/receives HTTP messages to/from Web servers 201 and 202.

The SIP-UAC module 143 communicates with the SIP-UAS to, e.g., establish or disconnect a SIP session. In this exemplary embodiment, the SIP-UAS is a Web server management apparatus 203.

The control module 141 performs main control of the PC terminal 101, and has a Web browser 154 and a SIP session management fiction 155. The SIP session management fiction 155 is a storage means for holding and managing the correspondence relationship between the SIP-URI of the self PC terminal 101, the SIP-URI of a partner for which a SIP session has been established using the SIP-URI of the PC terminal as a client SIP-URI, and a SIP session identifier that uniquely identifies the established SIP session. As the SIP session identifier, for example, a Call-ID is used.

Using the user authentication information management function 134 and the SIP session management function 135, the control module 141 controls establishment and disconnection of a SIP session for each user whose authentication by the user authentication function 133 has succeeded.

An operation of the communication system according to the exemplary embodiment will be described next using an example in which the user of the PC terminal 101 refers to a content in the Web server 201 using the Web browser 111 mainly concerning points different from the communication system in FIG. 1.

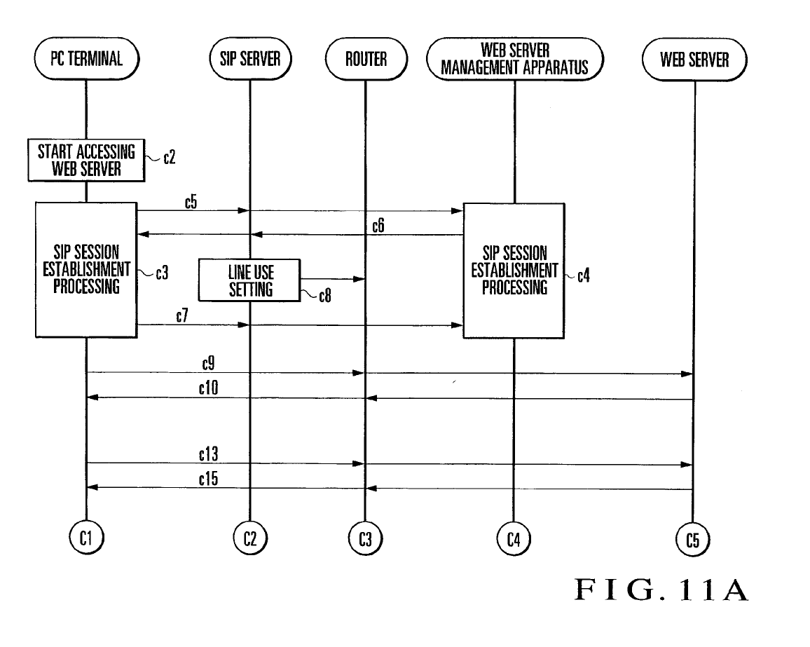

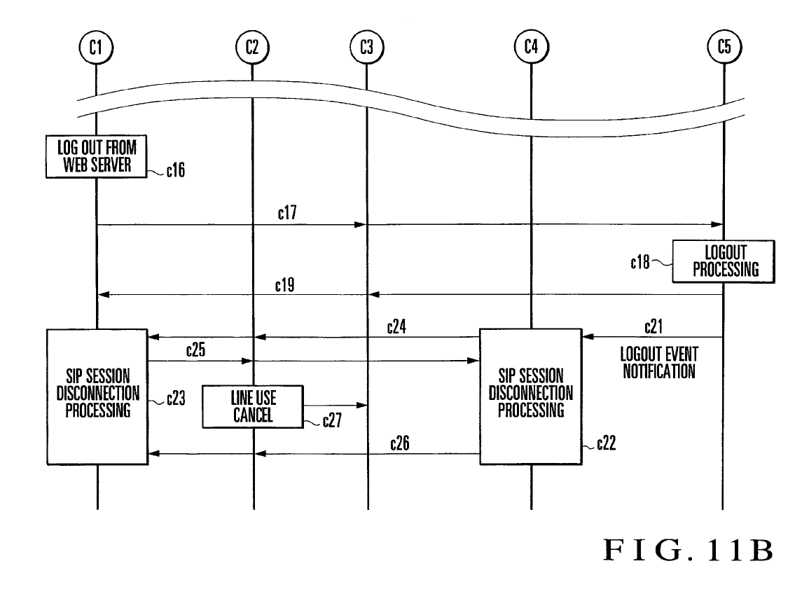

Referring to FIG. 11A, when the user of the PC terminal 101 starts accessing the Web server 201 by operating the Web browser 111 via the input/output device 146 (c2), the PC terminal 101 establishes a SIP session, via a SIP server 303 of a carrier network 300, for the Web server management apparatus 203 that manages the Web server 201 of the access destination (c3 and c4). The SIP session establishment processes c3 and c4 are the same as the processes a3 and a4 in FIG. 4A except that the PC terminal 101 itself executes the SIP session establishment processing that is performed by the communication session centralizing apparatus 103 on behalf of the PC terminal. The SIP session establishment processing is generally performed in the following way.

First, the PC terminal 101 transmits a SIP request (INVITE) to the Web server management apparatus 203 via the SIP server 303 (c5). The SIP request includes a client-side SIP-URI that is the SIP-URI of the PC terminal 101, a Web-server-side SIP-URI that is a SIP-URI in a one-to-one correspondence with the Web server 201 of the access destination, and an attribute such as QoS when using the carrier network 300.

The Web server management apparatus 203 analyzes the received SIP request, and confirms whether the user specified by the client-side SIP-URI has an authority to use the Web server 201 specified by the Web-server-side SIP-URI. If the user can use the Web server, the Web server management apparatus 203 transmits a SIP response representing a permission to the PC terminal 101 via the SIP server 303 (c6). On the other hand, if the user cannot use the Web server, the Web server management apparatus 203 transmits a SIP response representing a prohibition to the PC terminal 101 via the SIP server 303 (c6). The SIP response includes the IP address of the Web server 201. Upon receiving the SIP response, the PC terminal 101 transmits ACK for the SIP response to the Web server management apparatus 203 via the SIP server 303 (c7).

When receiving the SIP response representing a permission from the Web server management apparatus 203 and transferring it to the PC terminal 101, the SIP server 303 that relays the SIP response sets routers 301 and 302 such that a line of the carrier network 300 can be used between the Web server 201 specified by the server-side SIP-URI contained in the SIP response (or SIP request) and the PC terminal 101 specified by the client-side SIP-URI (c8). The routers 301 and 302 may be set not when transferring the SIP response but when receiving ACK for the SIP response from the PC terminal 101 and transferring it to the Web server management apparatus 203. The SIP server 303 which has done the use setting stores information to be used to cancel the current use setting in correspondence with the identifier of the currently established SIP session so as to prepare for later cancel of the use setting.

In the above-described way, the SIP session is established between the PC terminal 101 and the Web server management apparatus 203, and setting is done to allow the Web server 201 and the PC terminal 101 to use a line of the carrier network 300 via the routers 301 and 302. Then, normal HTTP communication is performed between the PC terminal 101 and the Web server 201 (c9: HTTP request, c10: HTTP response, c13: HTTP request, and c14: HTTP response). This processing is the same as in a9 to a14 of FIG. 4A except that the communication is done without intervening an HTTP proxy.

An operation to be performed when the user of the PC terminal 101 logs out from the Web server 201 will be described next with reference to FIG. 11B.

Processes c16 to c19 from the logout operation of the user of the PC terminal 101 from the Web server 201 up to HTTP response return to the PC terminal 101 are the same as the processes a16 to a20 in FIG. 4B except that the communication is done without intervening an HTTP proxy.

On the other hand, a SIP protocol communication function 252 of the Web server 201 which has executed the logout processing c18 accordingly executes SIP session disconnection processing between the Web server and the PC terminal 101 via the SIP server 303 of the carrier network 300 (c22 and c23). The SIP session disconnection processes c22 and c23 are the same as the processes a22 and a23 in FIG. 4B except that the PC terminal 101 itself executes the SIP session disconnection processing that is performed by the communication session centralizing apparatus 103 on behalf of the PC terminal. The SIP session disconnection processing is generally performed in the following way.

First, the Web server management apparatus 203 transmits a SIP request (BYE) to the PC terminal 101 via the SIP server 303 (c24). The SIP request includes the SIP session identifier of the SIP session to be disconnected, the client-side SIP-URI, and the Web-server-side SIP-URI. The PC terminal 101 analyzes the received SIP request, disconnects the SIP session specified by the SIP session identifier, and transmits a SIP response to the Web server management apparatus 203 via the SIP server 303 (c25). Upon receiving the SIP response, the Web server management apparatus 203 transmits ACK for the SIP response to the PC terminal 101 via the SIP server 303 (c26).

When receiving the SIP response representing SIP session disconnection from the PC terminal 101 and transferring it to the Web server management apparatus 203, the SIP server 303 that relays the SIP response controls the routers 301 and 302 to cancel the use setting of the carrier network 300 between the Web server 201 and the PC terminal 101 by referring to the information stored in correspondence with the SIP session identifier contained in the SIP response (c27). Setting of the routers 301 and 302 may be canceled not when transferring the SIP response but when receiving ACK for the SIP response from the Web server management apparatus 203 and transferring it to the PC terminal 101.

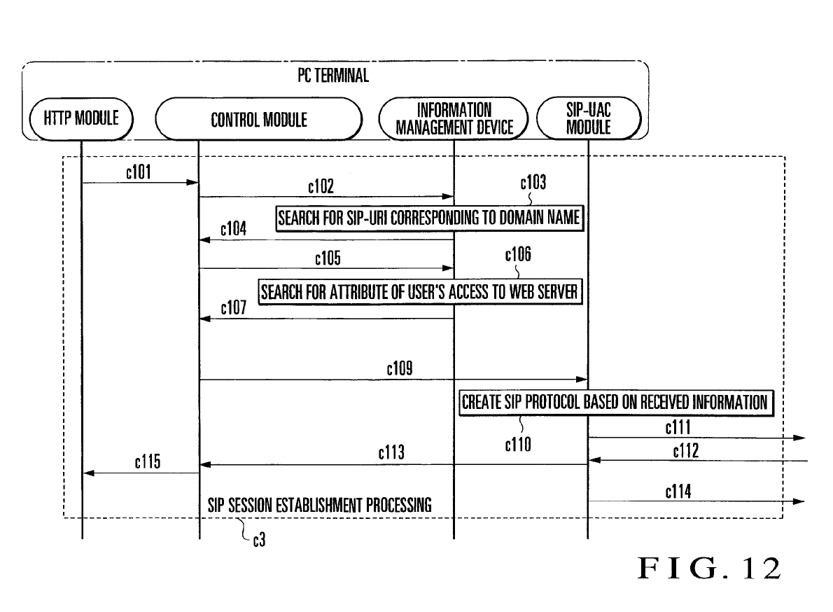

The SIP session establishment processing c3 in FIG. 11A will be described next in detail with reference to FIG. 12.

Referring to FIG. 12, the HTTP module 142 of the PC terminal 101 notifies the control module 141 of the domain name of the URL of the Web server 201 contained in the access request received from the Web browser 111 and the user name of the PC terminal 101 (c101).

The control module 141 sends the domain name of the URL of the Web server 201 to the information management device 144, and requests it to acquire the Web-server-side SIP-URI corresponding to the domain name (c102). The information management device 144 searches the SIP-URI table 151 for the Web-server-side SIP-URI corresponding to the received domain name, and sends it to the control module 141 (c103 and c104).

Next, the control module 141 sends the user name and the Web-server-side SIP-URI to the information management device 144, and requests it to acquire attribute information (c105). The information management device 144 searches the attribute information table 152 for attribute information corresponding to the combination of the received user name and Web-server-side SIP-URI, and sends it to the control module 141 (c106 and c107).

The control module 141 sends the client-side SIP-URI (the SIP-URI of the PC terminal 101), Web-server-side SIP-URI, and attribute information to the SIP-UAC module 143, and requests it to start a SIP session (c109).

In accordance with the request from the control module 141, the SIP-UAC module 143 creates a SIP request (SIP protocol: INVITE) based on the received information, and transmits it to the SIP server 303 of the carrier network 300 (c110 and c111). The Web-server-side SIP-URI is set in the Request-URI and To header of the SIP request. The client-side SIP-URI is set in the From header. The attribute information is described in the SDP (Session Description Protocol) field.

As described with reference to FIG. 11A, the SIP server 303 transmits the received SIP request to the Web server management apparatus 203 specified by the server-side SIP-URI described in the To header (c5).

After that, upon receiving the SIP response (the SIP protocol of the SIP response stores the IP address of the Web server) from the SIP server 303 of the carrier network 300 (c112), the SIP-UAC module 143 of the PC terminal 101 notifies the control module 141 of the permission/prohibition of SIP session establishment that can be known from the SIP response (c113). The SIP-UAC module 143 also transmits ACK for the SIP response to a SIP protocol communication function 222 of the Web server management apparatus 203 via the SIP server 303 (c114). The control module 141 sends the SIP response received from the SIP-UAC module 143 to the HTTP module 142 (c115). The control module 141 also registers the set of the client-side SIP-URI, server-side SIP-URI, and SIP session identifier in the SIP session management fiction 155 as information about the established SIP session.

The HTTP module 142 acquires and holds the IP address of the Web server 201 contained in the received SIP response and the SIP session identifier of the established SIP session. When performing HTTP communication between the PC terminal 101 and the Web server 201 specified by the IP address, the HTTP module 142 stores the SIP session identifier in the extension header of an HTTP message.

The effects of this exemplary embodiment will be explained next.

According to the exemplary embodiment, out of the above-described effects (1) to (6) obtained in the exemplary embodiment described with reference to FIG. 1, the effects (4) to (6) are obtained. In the exemplary embodiment described with reference to FIG. 1, a failure in the communication session centralizing apparatus makes all PC terminals managed by it unaccessible to the Web server. In the second exemplary embodiment, however, since each PC terminal has the SIP protocol processing function, the resistance against failures can be increased.

### Third Exemplary Embodiment

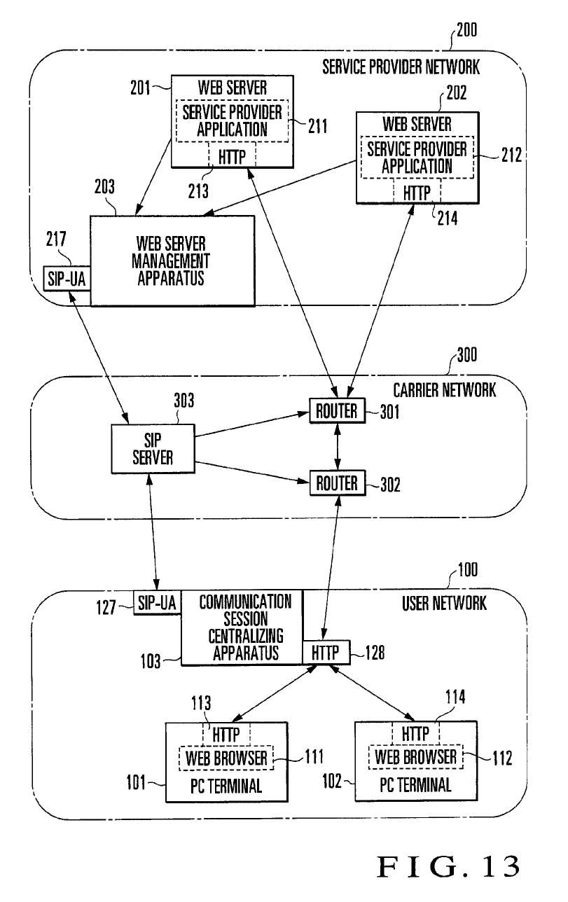

Referring to FIG. 13, a communication system according to the third exemplary embodiment of the present invention is different from the communication system shown in FIG. 1 in that a Web server management apparatus 203 includes no shared-authentication module 221. The arrangement of this exemplary embodiment will be described below mainly concerning the points different from FIG. 1.

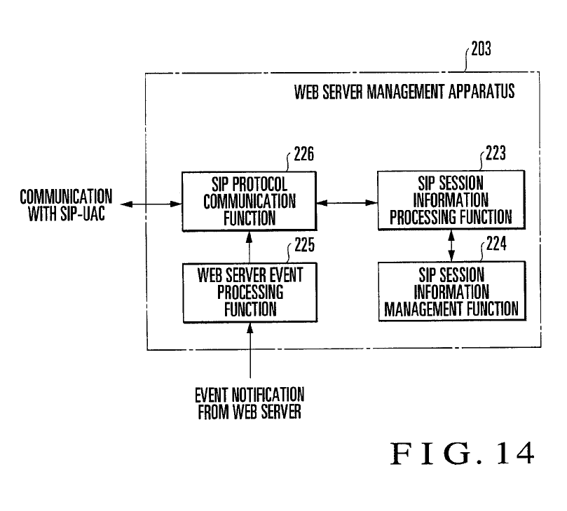

Referring to FIG. 14, the Web server management apparatus 203 is different from that shown in FIG. 3 and used in the communication system in FIG. 1 in that the shared-authentication module 221 is not provided, and a SIP protocol communication function 226 replaces the SIP protocol communication function 222.

The SIP protocol communication function 226 is different from the SIP protocol communication function 222 in that the function concerning the shared-authentication module 221 is not included.

An operation of the communication system according to the exemplary embodiment will be described next using an example in which the user of a PC terminal 101 refers to a content in a Web server 201 using a Web browser 111 mainly concerning points different from the communication system in FIG. 1.

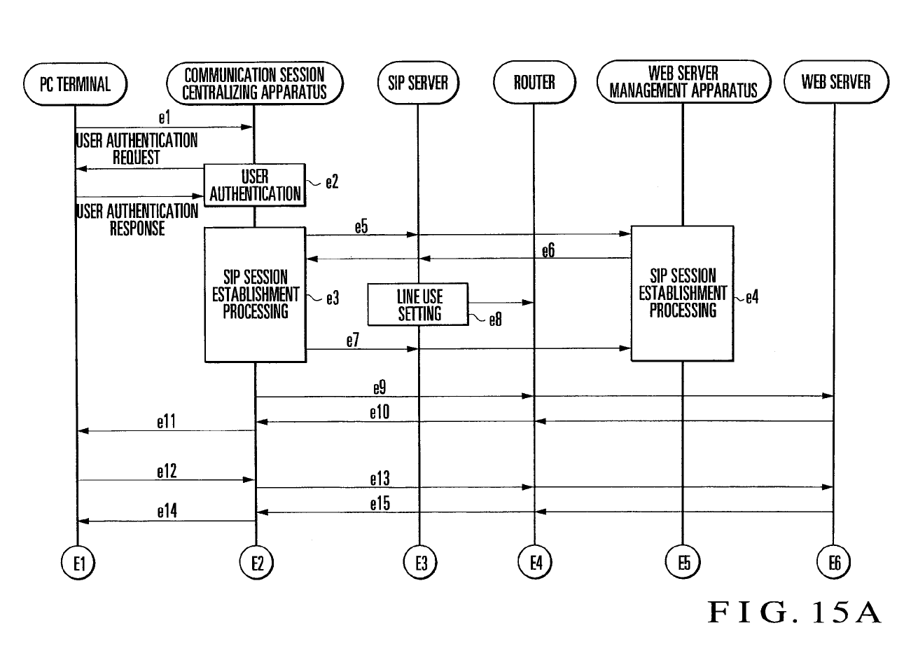

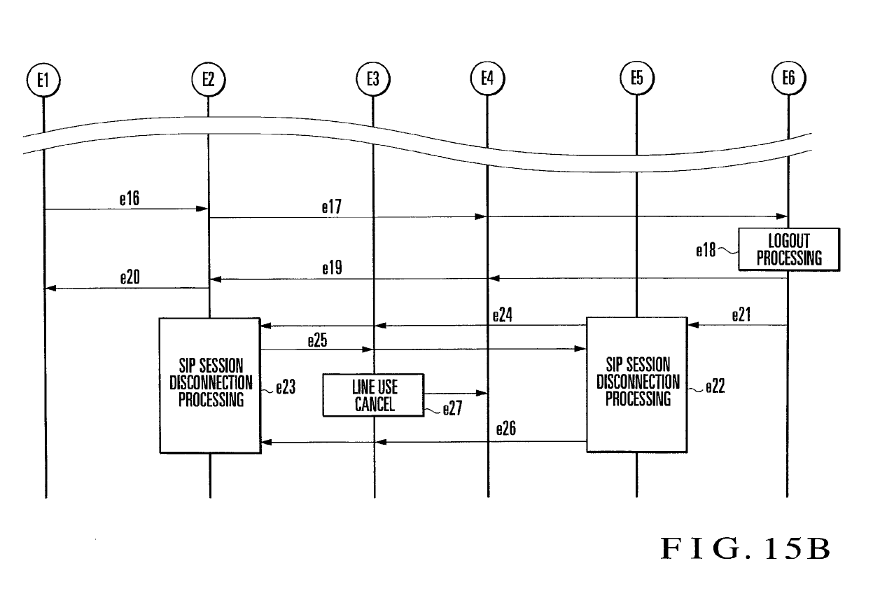

FIGS. 15A and 15B show the procedure of a sequence in the same situation as in FIGS. 4A and 4B. Processes e1 to e3 and e5 to e26 are the same as the processes a1 to a3 and a5 to a26 in FIGS. 4A and 4B. SIP session establishment processing e4 executed by the Web server management apparatus 203 is different from the processing a4 in FIG. 4A in that processing concerning the shared-authentication module is omitted.

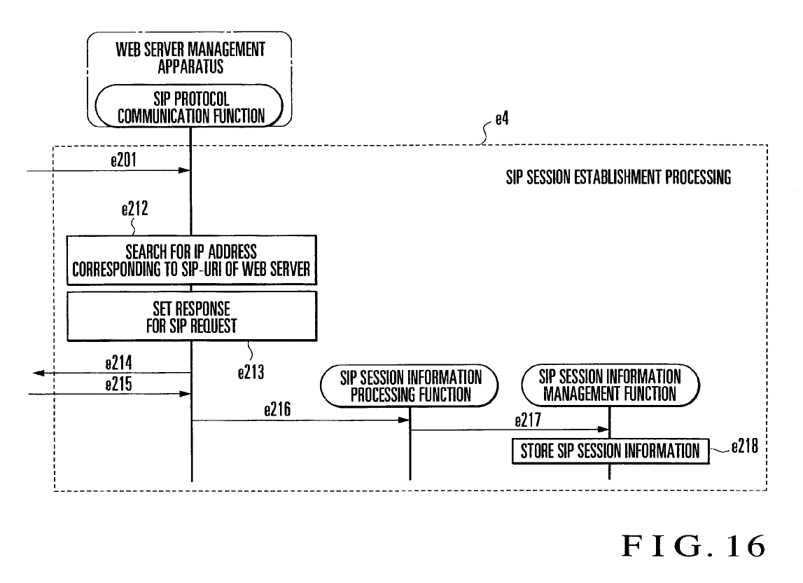

The SIP session establishment processing e4 in FIG. 15A will be described in detail with reference to FIG. 16.

Referring to FIG. 16, upon receiving a SIP request from a communication session centralizing apparatus 103 via a SIP server 303 of a carrier network 300 (e201), the SIP protocol communication function 226 of the Web server management apparatus 203 searches for an IP address corresponding to the server-side SIP-URI contained in the SIP request (e212). This search is done by, for example, storing, in the Web server management apparatus 203, a correspondence list of the IP addresses of the Web servers 201 and 202 managed by the apparatus and server-side SIP-URIs set in the apparatus 203 in a one-to-one correspondence with the Web servers 201 and 202, and searching for the correspondence list based on the Web-server-side SIP-URI.

The SIP protocol communication function 226 next creates a response for the SIP request (e213), and transmits it to the SIP server 303 of the carrier network 300 (e214). More specifically, for permission, the SIP protocol communication function 226 creates “200 OK” as a SIP response and transmits it. Otherwise, the SIP protocol communication function 226 creates a SIP response representing an error such as “403 Forbidden” and transmits it. The SIP protocol communication function 226 stores the IP address of the Web server 201 in the SIP response.

Upon receiving ACK for the SIP response from the communication session centralizing apparatus 103 (e215), the SIP protocol communication function 226 of the Web server management apparatus 203 requests a SIP session information processing function 223 to set the status information of the established SIP session (e216). Upon receiving the request, the SIP session information processing function 223 stores the status information of the established SIP session in a SIP session information management function 224 (e217 and e218).

The effects of this exemplary embodiment will be explained next.

According to the exemplary embodiment, out of the above-described effects (1) to (6) obtained in the exemplary embodiment described with reference to FIG. 1 the effects (1) to (4) and (6) are obtained.

### Fourth Exemplary Embodiment

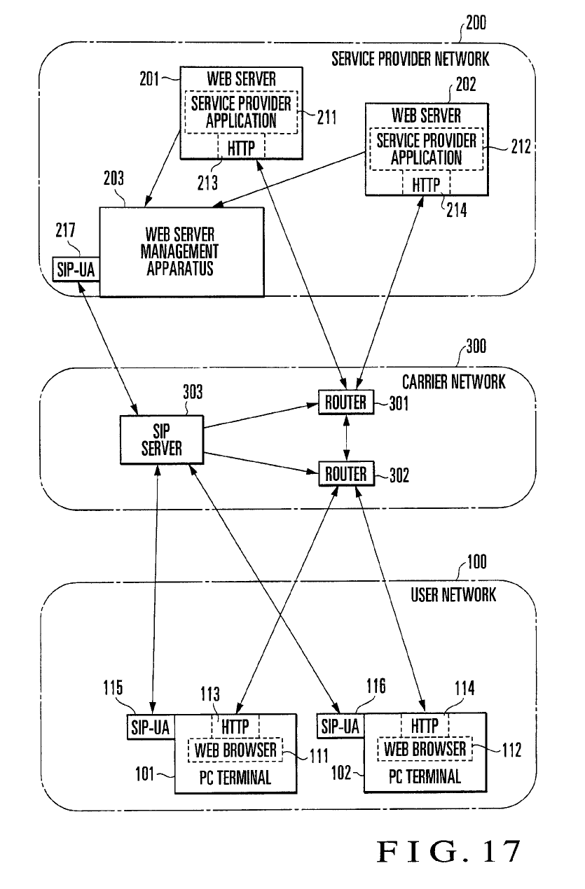

Referring to FIG. 17, a communication system according to the fourth exemplary embodiment of the present invention is different from the communication system shown in FIG. 1 in that a Web server management apparatus 203 includes no shared-authentication module 221, and PC terminals 101 and 102 themselves have SIP-UA functions 115 and 116, respectively. For this reason, a user network 100 does not include the communication session centralizing apparatus 103 shown in FIG. 1. The arrangement of this exemplary embodiment will be described below mainly concerning the points different from FIG. 1.

The arrangement of the PC terminals 101 and 102 according to this exemplary embodiment is the same as that of the PC terminals 101 and 102 in the communication system shown in FIG. 9. The arrangement of the Web server management apparatus 203 according to this exemplary embodiment is the same as that of the Web server management apparatus 203 in the communication system shown in FIG. 13.

An operation of the communication system according to the exemplary embodiment will be described next using an example in which the user of the PC terminal 101 refers to a content in a Web server 201 using a Web browser 111 mainly concerning points different from the communication system in FIG. 1.

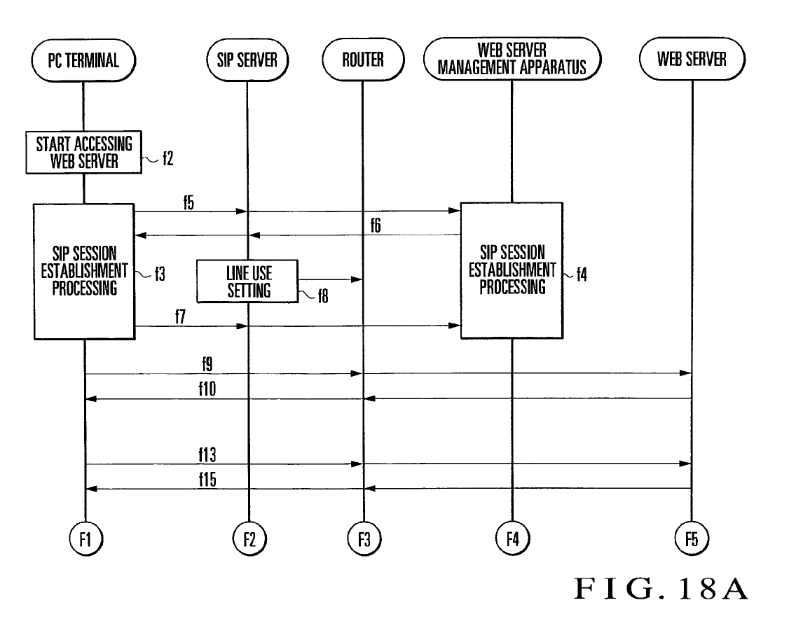

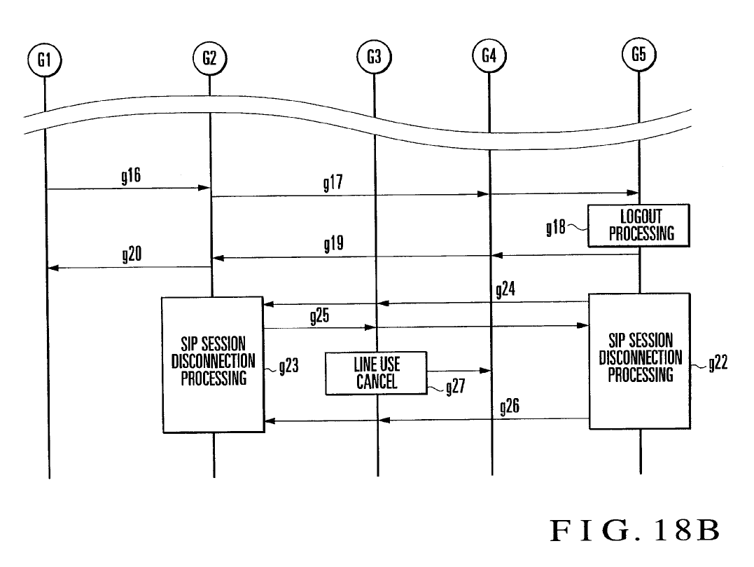

FIGS. 18A and 18B show the procedure of a sequence in the same situation as in FIGS. 11A and 11B. Processes f1 to f3 and f5 to f26 are the same as the processes c1 to c3 and c5 to c26 in FIGS. 11A and 11B. SIP session establishment processing f4 executed by the Web server management apparatus 203 is the same as the processing e4 (details are shown in FIG. 16) in FIG. 15A.

The effects of this exemplary embodiment will be explained next.

According to the exemplary embodiment, out of the above-described effects (1) to (6) obtained in the exemplary embodiment described with reference to FIG. 1, the effects (4) and (6) are obtained.

The exemplary embodiments of the present invention have been described above. The present invention is not limited to only the above exemplary embodiments, and various additions and modifications can be made. For example, in the above-described example, a PC terminal and a server performs HTTP communication. However, the protocol is not limited to the HTTP protocol, and any other protocol such as FTP communication is also usable. A PC terminal has been exemplified above as a user terminal. However, the terminal apparatus is not limited to the PC terminal if it can be connected to the carrier network. The communication session centralizing apparatus, Web server management apparatus, and shared-authentication module can be implemented by a computer and programs. The programs are recorded on a computer-readable recording medium such as a magnetic disk or a semiconductor memory and provided. When, e.g., activating the computer, the programs are read out by the computer to control its operation so that the computer functions as the communication session centralizing apparatus, Web server management apparatus, and shared-authentication module of the above-described exemplary embodiments.

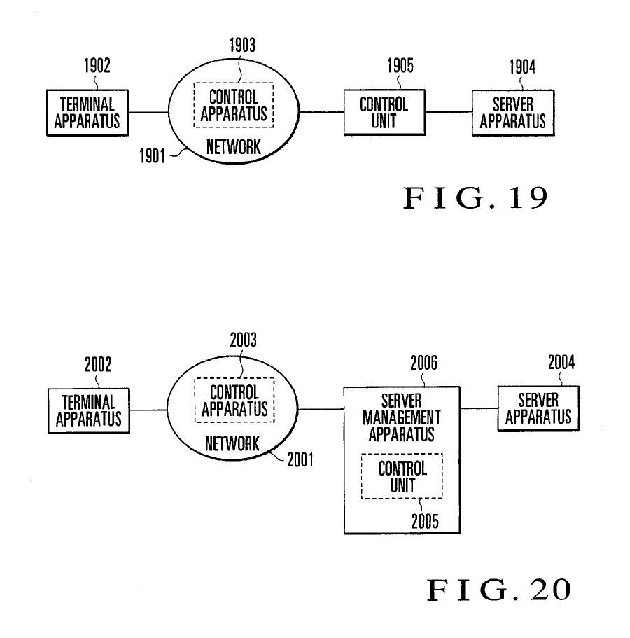

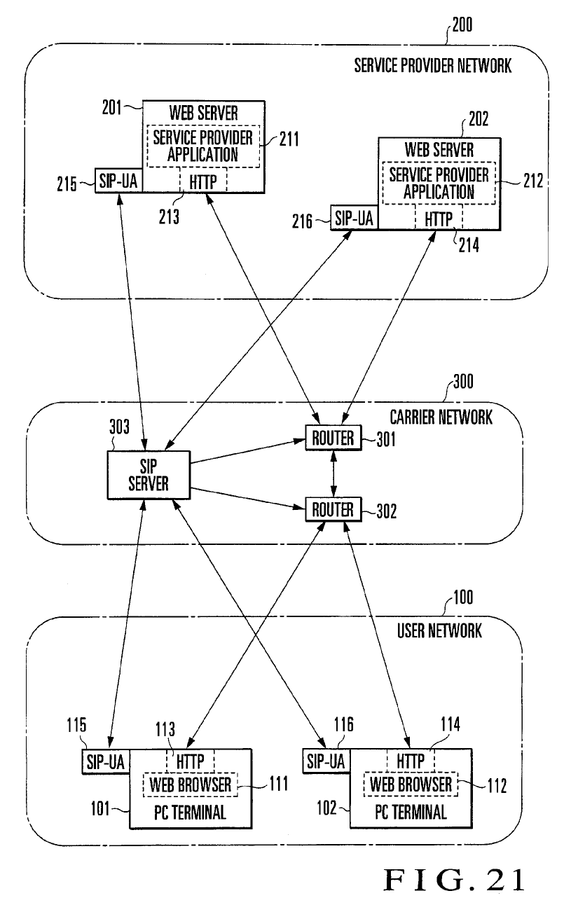

Note that, as shown in FIG. 19, the server management apparatus according to the present invention basically includes a control unit 1905 that performs processing of establishing a session for a terminal apparatus 1902 serving as a communication partner terminal via a control apparatus 1903 of a network 1901 using a predetermined signaling protocol to obtain a use permission of the network 1901 on behalf of at least one server apparatus 1904 that provides a service to the terminal apparatus 1902 via the network 1901. This is a characteristic feature of the arrangement of the server management apparatus. Note that the control unit 1905 is provided between the server apparatus 1904 and the network 1901. This arrangement enables even the server apparatus 1904 having no SIP-UA to access the terminal apparatus 1902 via the network 1901 which becomes usable upon obtaining a permission under the control of the control unit 1905.

In addition, as shown in FIG. 20, the communication system according to the present invention basically includes a server management apparatus 2006 including a control unit 2005 that performs processing of establishing a session for a terminal apparatus 2002 serving as a communication partner terminal via a control apparatus 2003 of a network 2001 using a predetermined signaling protocol to obtain a use permission of the network 2001 on behalf of a server apparatus 2004 to which the terminal apparatus 2002 accesses via the network 2001. This is a characteristic feature of the arrangement of the communication system. This arrangement enables even the server apparatus 2004 having no SIP-UA to access the terminal apparatus 2002 via the network 2001 which becomes usable upon obtaining a permission under the control of the control unit 2005.

The present invention has been described above with reference to the exemplary embodiments. However, the present invention is not limited to the above-described exemplary embodiments. The arrangement and details of the invention can be variously modified within the scope of the invention, and these modifications will readily occur to those skilled in the art.

This application is based upon and claims the benefit of priority from Japanese patent application No. 2007-302624, filed on Nov. 22, 2007, the disclosure of which is incorporated herein in its entirety by reference.

1. A communication system comprising a server management apparatus including a control unit that performs processing of establishing a session for a communication partner terminal via a control apparatus of a network using a predetermined signaling protocol to obtain a use permission of the network on behalf of a server apparatus to which a terminal apparatus accesses via the network.

2. A communication system according to claim 1, wherein
said server management apparatus comprises a storage unit that holds status information including a server identifier to be used to uniquely identify the server apparatus, the communication partner terminal that is accessing the server apparatus, and a session identifier to be used to uniquely identify the session, and
said control unit records the status information of the session in said storage unit when establishing the session.

3. A communication system according to claim 2, wherein when disconnecting the session, said control unit deletes the status information of the disconnected session from said storage unit.

4. A communication system according to claim 1, wherein said control unit disconnects the session in synchronism with an event notification output from the server apparatus.

5. A communication system according to claim 4, wherein the event notification represents that a user of the terminal apparatus has logged out from the server apparatus.

6. A communication system according to claim 4, wherein the event notification represents that a user of the terminal apparatus has failed in logging in to the server apparatus.

7. A communication method comprising the first step of performing processing of establishing a session for a communication partner terminal via a control apparatus of a network using a predetermined signaling protocol to obtain a use permission of the network on behalf of a server apparatus to which a terminal apparatus accesses via the network.

8. A communication method according to claim 7, wherein the first step comprises the second step of recording, in storage means for holding status information including a server identifier to be used to uniquely identify the server apparatus, the communication partner terminal that is accessing the server apparatus, and a session identifier to be used to uniquely identify the session, the status information of the session when establishing the session.

9. A communication method according to claim 8, wherein the first step comprises the third step of, when disconnecting the session, deleting the status information of the disconnected session from the storage means.

10. A communication method according to claim 7, wherein the first step comprises the fourth step of disconnecting the session in synchronism with an event notification output from the server apparatus.

11. A communication method according to claim 10, wherein the event notification represents that a user of the terminal apparatus has logged out from the server apparatus.

12. A communication method according to claim 10, wherein the event notification represents that a user of the terminal apparatus has failed in logging in to the server apparatus.

13. A server management apparatus comprising a control unit that performs processing of establishing a session for a communication partner terminal via a control apparatus of a network using a predetermined signaling protocol to obtain a use permission of the network on behalf of at least one server apparatus that provides a service to a terminal apparatus via the network,
the server management apparatus being provided between the server apparatus and the network.

14. A server management apparatus according to claim 13, further comprising a storage unit that holds status information including a server identifier to be used to uniquely identify the server apparatus, the communication partner terminal that is accessing the server apparatus, and a session identifier to be used to uniquely identify the session,
wherein said control unit records the status information of the session in said storage unit when establishing the session.

15. A server management apparatus according to claim 14, wherein when disconnecting the session, said control unit deletes the status information of the disconnected session from said storage unit.

16. A server management apparatus according to claim 13, wherein said control unit disconnects the session in synchronism with an event notification output from the server apparatus.

17. A server management apparatus according to claim 16, wherein the event notification represents that a user of the terminal apparatus has logged out from the server apparatus.

18. A server management apparatus according to claim 16, wherein the event notification represents that a user of the terminal apparatus has failed in logging in to the server apparatus.

19. A computer-readable storage medium storing a program which causes a computer constructing a server management apparatus provided between a network and at least one server apparatus that provides a service to a terminal apparatus via the network to function as control means for performing processing of establishing a session for a communication partner terminal via a control apparatus of the network using a predetermined signaling protocol to obtain a use permission of the network on behalf of the server apparatus.

20. A computer-readable storage medium storing a program according to claim 19, wherein
the computer comprises storage means for holding status information including a server identifier to be used to uniquely identify the server apparatus, the communication partner terminal that is accessing the server apparatus, and a session identifier to be used to uniquely identify the session, and
said control means records the status information of the session in said storage means when establishing the session.

21. A computer-readable storage medium storing a program according to claim 20, wherein when disconnecting the session, said control means deletes the status information of the disconnected session from said storage means.

22. A computer-readable storage medium storing a program according to claim 19, wherein said control means disconnects the session in synchronism with an event notification output from the server apparatus.

23. A computer-readable storage medium storing a program according to claim 22, wherein the event notification represents that a user of the terminal apparatus has logged out from the server apparatus.

24. A computer-readable storage medium storing a program according to claim 22, wherein the event notification represents that a user of the terminal apparatus has failed in logging in to the server apparatus.

25. A communication system comprising a server management apparatus including control means for performing processing of establishing a session for a communication partner terminal via a control apparatus of a network using a predetermined signaling protocol to obtain a use permission of the network on behalf of a server apparatus to which a terminal apparatus accesses via the network.

26. A server management apparatus comprising control means for performing processing of establishing a session for a communication partner terminal via a control apparatus of a network using a predetermined signaling protocol to obtain a use permission of the network on behalf of at least one server apparatus that provides a service to a terminal apparatus via the network,
the server management apparatus being provided between the server apparatus and the network.
